(19) United States
(12) Patent Application Publication
(10) Pub. No.: US 2010/0211519 A1
(43) Pub. Date: Aug. 19, 2010

(54) METHOD AND SYSTEM FOR PROCESSING REAL-TIME, ASYNCHRONOUS FINANCIAL MARKET DATA EVENTS ON A PARALLEL COMPUTING PLATFORM

(75) Inventor: Alberto E. Giannetti, New York, NY (US)

Correspondence Address: FOLEY HOAG, LLP;PATENT GROUP, WORLD TRADE CENTER WEST, 155 SEAPORT BLVD, BOSTON, MA, 02110, US

(73) Assignee: Parallel Trading Systems, Inc., Wilmington, DE (US)

(21) Appl. No.: 12/372,184

(22) Filed: Feb. 17, 2009

(51) Int. Cl. G06Q 40/00; G06F 15/173; G06F 15/167

(52) U.S. Cl. 705/36 R; 709/226; 709/212

(57) ABSTRACT

A method and system are provided for real-time, asynchronous processing of financial market data events on a parallel computing platform having a plurality of computer processes executing on one or more computers. The method includes: (a) receiving a generally continuous stream of market data events from an electronic exchange over a computer network; (b) sequentially storing the market data events received in (a) in at least one data queue; (c) distributing the market data events among the plurality of computer processes on a first in, first out basis such that the market data events can be processed by the processes in a coordinated fashion; (d) processing the market data events distributed in (c) at the respective computer processes using financial models to generate trading information on one or more financial instruments; and (e) making the trading information generated in (d) available through a common API or a client GUI to the a user.

### FIELD OF THE INVENTION

The present application relates to the processing of real-time financial data from electronic exchanges and, more particularly, to a method and system for processing real-time, asynchronous financial market data events on a parallel computing platform of inter-connected, multi-core nodes.

### BACKGROUND

The majority of financial securities issued by private companies and country governments are traded on centralized electronic exchanges and private electronic networks. Orders sent by buyers and sellers connected through network systems are automatically matched on the electronic marketplace, producing extremely rapid sequences of order requests and execution data, in the order of several thousand updates per second for each exchange.

Electronic exchanges are generally organized by the type of financial security traded (stocks, corporate bonds, options, commodity futures, index futures, etc.) and the geographical location of the issuing organizations (United States, Europe, Asia, regional markets).

The continuous negotiations between buyers and sellers generate streams of real-time market data to inform market participants of the active orders in each side of the trade, best quotes, executed transactions, trading status, and electronic markets status. Combined for all financial instruments and electronic exchanges in the world, this flow of data can account for several thousand updates per second that must be processed by electronic trading and risk management systems. The high-degree of volatility correlation shown by the financial instruments requires market participants to include several securities and large quantities of data to evaluate each order request to buy and sell securities and assess various degrees of operating risk.

Data streams are generally organized in time-series, that is, sets of homogenous data points distributed in time. Most sophisticated trading systems implement mathematical models to evaluate the flow of the exchange data in real-time to price financial instruments, manage risk, and automatically make trading decisions resulting in near-instantaneous orders to buy or sell securities.

Parallel computing is a form of computation in which several sets of computer instructions are executed concurrently on different processors or CPU cores, to reduce calculation time. Parallel computing is largely adopted in scientific disciplines such as molecular research, weather forecasting, chemical analysis, and medical fields to solve complex mathematical problems on large sets of data.

A software communication layer known as middleware is used to decompose complex problems and distribute data over several processors. One of the most common middleware used in the scientific fields mentioned above is the Message Passing Interface (MPI) open standard. MPI offers a method and software coding standards to distribute computing tasks on multiple machines by exchanging data between computers in a standard format and defining a set of operating system process collective operations.

### BRIEF SUMMARY OF EMBODIMENTS OF THE INVENTION

In accordance with one or more embodiment of the invention, a method is provided for real-time, asynchronous processing of financial market data events on a parallel computing platform having a plurality of computer processes executing on one or more computers and communicating by the rules and processes defined by the Message Passing Interface (MPI). The method includes: (a) receiving a generally continuous stream of market data events from an electronic exchange over a computer network; (b) sequentially storing the market data events received in (a) in at least one data queue; (c) distributing the market data events among the plurality of computer processes on a first in, first out basis such that the market data events can be processed by the processes in a coordinated fashion; (d) processing the market data events distributed in (c) at the respective computer processes using financial models to generate trading information on one or more financial instruments; and (e) making the trading information generated in (d) available through a common API or a client application to the user.

In accordance with one or more embodiments of the invention, a system is provided for for real-time, asynchronous processing of financial market data events on a parallel computing platform having a plurality of computer processes executing on one or more computers. The system includes a market data component for receiving a generally continuous stream of market data events from an electronic exchange over a computer network, and sequentially storing the market data events received in at least one data queue. The system also includes a computing cluster comprising a plurality of computer processes. The system further includes a process for distributing the market data events among the plurality of computer processes in the computing cluster on a first in, first out basis such that the market data events can be processed by the processes in a coordinated fashion using financial models to generate trading information on one or more financial instruments. The system also includes a process for making the trading information available through a common API or a client application to a user.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 illustrates an exemplary network layout and the hardware employed in a typical electronic exchange connectivity solution in accordance with one or more embodiments of the invention.

FIG. 2 illustrates an exemplary system for real-time parallel processing of market data in accordance with one or more embodiments of the invention.

FIG. 3 illustrates an exemplary system for real-time parallel processing of market data in accordance with one or more alternate embodiments of the invention.

FIG. 4 illustrates an exemplary organization of data processed by the system represented as a set of two-dimensional arrays in accordance with one or more embodiments of the invention.

### DETAILED DESCRIPTION

In accordance with one or more embodiments of the invention, a method and system are provided for parallel processing of real-time market data events using an API such as the MPI open standard to distribute market data events to multiple processes while preserving data consistency. Market data events received from an exchange are stored in a sequential data queue and distributed asynchronously to one or more MPI parallel tasks on the same computer or multiple computers on the same cluster of computers for parallel processing, as determined by the underlying OS (operating system) scheduler and hardware processor availability, thus increasing computing efficiency while simplifying the network layout. MPI processes are synchronized for ordered access to the list of sequential market data events, independently of their location on the computer cluster. Access is provided to a complete set of current and historical market data events stored on one or more computers through a software API. The programs are allowed to execute parallel operations through MPI collective functions on a set of financial instrument time-series at any point in time.

Electronic exchanges (e.g., NASDAQ, CME, NYSE, etc.) generate frequent updates resulting from the trading activity on each supported security. Examples of market updates are: the last completed transaction between a buyer and a seller (including transaction price and size), best offered and asked price, cancellation of a particular offer to buy or sell a security, and the notification of special conditions on the instrument such as the suspension from trading activity. Market data events are delivered in rapid sequence, reaching a frequency of updates in the order of several thousand messages per second for the most highly traded securities. The data is usually delivered to trading systems on high-bandwidth networks such as T1, ISDN, DSL, private lines, or another physical layer provided by the exchange. Trading systems receiving the data should insure proper handling of the data by connecting to the exchange network channel with appropriate hardware, including dedicated servers providing enough network bandwidth and processing power.

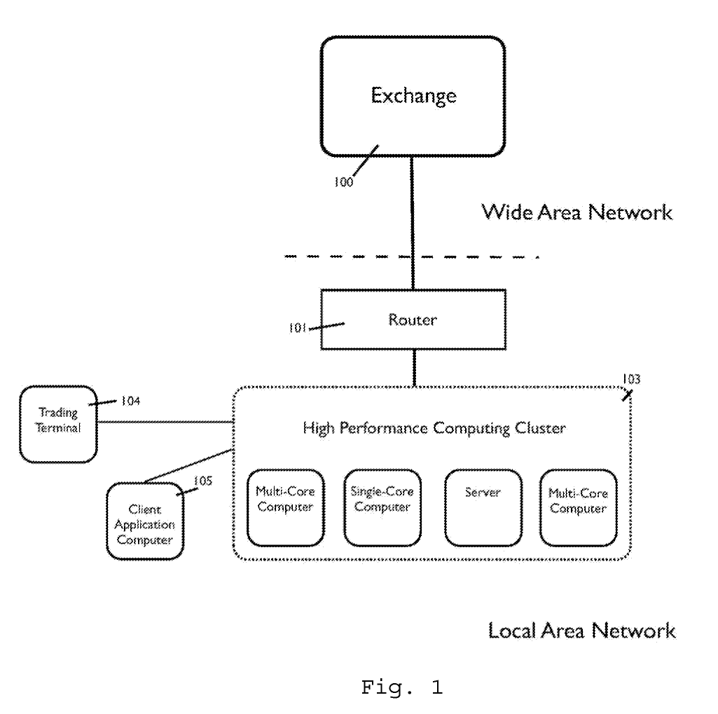

FIG. 1 illustrates an example of an electronic trading system setup connected to an electronic exchange 100. The trading system hardware includes a network router 101, a set of one or more computer servers 103, a user client computer 105, and a trading terminal 104.

Data broadcasted from an electronic exchange requires specific processing as determined by the requirements and algorithms of each financial model. To provide some background on the degree of complexity related to the processing of high-frequency market data events, a brief review of an exemplary trading system is now described.

An electronic trading system includes several software components, or servers, dedicated to specific tasks. This may include, in a typical configuration: market data handler, position servers, risk servers, automated traders, order routing and execution infrastructures. One or more market data handlers are generally dedicated to the reception of incoming data from a number of electronic exchange sources. Data is stored by the market data handler in the computer memory, RAM, SSD or hard disk and made available to any other component in the system. Position servers keep track of buy and sell transactions executed automatically by the system or manually by one or more traders. Risk servers may calculate various statistics related to the risk associated with each security or sets of instruments, such as volatility, market risk, and industry-specific risk. Automated traders analyze all the values produced by the components described above and ultimately execute instructions to buy, sell, or sell short securities. Order routing and execution infrastructures insure the delivery of each request to the appropriate electronic exchange and the management of open orders in case of system failure.

Continuous growth in market data, development of new electronic markets and liquidity pools, and the commoditization of goods and services (e.g., energy futures, insurance contracts, government debt, emerging market debt, etc.) poses severe constraints on financial operators, requiring the development of complex technology infrastructures to process increasing quantities of financial data in real-time.

In addition to the aforementioned constraints related to computing power and responsiveness to real-time events, it should be understood that most financial time-series events are processed in strict sequential order. For example, assuming a sequence of market-generated data points T1, T2, T3, Tn, a financial computer program must proceed to analyze these events in the exact same order as generated by the data source for the outcome of the analysis to be consistent. Continuing with the above example, processors P1 will proceed to process event T1, while processor P2 will process event T2. However, the output results of P2 might occur before the execution of P1 has completed, therefore invalidating the correct sequence of events. This processing constraint, known by the person skilled in the art as data-dependency, constitute a severe limit to classic parallel computing when applied to real-time events, because the execution order of a multitude of processors on common hardware platforms cannot be pre-determined.

To analyze financial data in real-time while maximizing computing resources, one or more of the following techniques have been used: (a) dedicating a single computer process to one exchange data stream, thus processing all the events from the exchange, or a multitude of exchanges, sequentially, or (b) partitioning exchange securities in several subsets and allocating each subset to a specific process which may reside on a dedicated computer, or (c) allocating a number of software threads within a single computer to process data for one or more exchanges.

Solution (a) uses a sequential, single-computer, single-CPU, software program. This solution avoids the issues found in parallel computing when processing data-dependent sources. However, execution of other automated tasks found in a trading system will be delayed by the time required by the aforementioned process to complete its task, causing the delay to be larger in times of market stress, that is when minimum latency in data processing is mostly needed. Solution (b) allows one or more CPUs, or CPU cores, to effectively process several data streams while employing a larger set of computers and processors without incurring parallel processing data-dependency issues, that is dedicating specific sub-groups of securities to specific nodes. However, this solution forces users to cope with financial information residing on various computers and complex network layouts, possibly adding software components to locate each source of data and adding to hardware costs. In addition, the data load of each security cannot be pre-determined, thus pre-allocating a number of arbitrary securities to a specific computer might result in a set of high-volume financial instruments being allocated to the same host, precluding the intended benefit of the solution. Solution (c) is limited to a single computer, thus only the CPUs, or CPU cores, available on the computer can be used for parallel processing. In addition, solution (c) presents a number of operating systems synchronization issues known as context switching. Operating systems context switching introduces significant processing latency as the number of processors and concurrent processing increase.

In accordance with one or more embodiments of the present invention, market data events are processed on a hardware cluster by delivering each market data event to one of several MPI processes (as specified by the user), thus exploiting the multi-core capabilities of a single server and the set of nodes available on a high-performance cluster LAN (Local Area Network). A user of the system such as a system administrator can specify how many processes will run on the cluster; declare a process affinity for each available CPU core on a specific server or across the LAN; specify if the events should be persisted on mass storage or simply processed in memory; and discard specific events for one or more instruments. In addition, the system user can dynamically increase the number of CPU cores dedicated to the processing of a security data stream, according to the user computing requirements and the quantity of data that must be processed in real-time, thus more efficiently allocating the cluster resources.

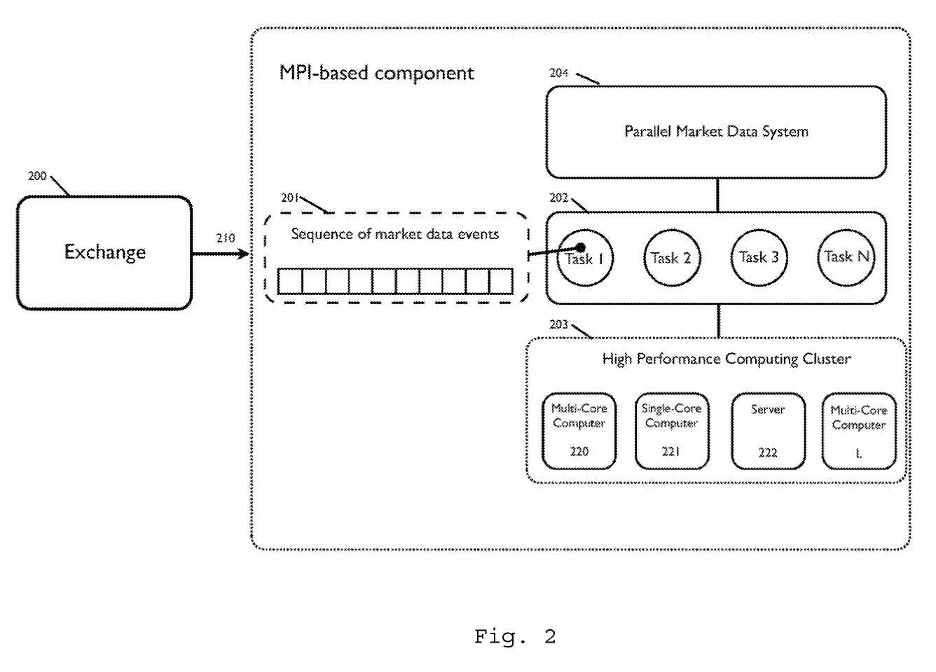

An exemplary system for processing market data events in accordance with one or more embodiments of the invention is shown in FIG. 2. A market data component of a trading system is linked to an electronic exchange 200 by a high-performance, highly-reliable network, in a point-to-point or multicast fashion 210. The exchange delivers market data events on a continuous stream of data blocks defined by the exchange proprietary protocol and usually supported by TCP/IP or UDP transports.

The market data handler comprises a number of MPI processes (i.e., tasks) 202 running on a cluster of computers 203 connected by high-performance network interface card (NIC), e.g., Giga Ethernet, 10 Gig Ethernet or another proprietary standard such as Quadrics Qnet, Infiniband, or Myrinet. Only the combined set of computers in a cluster and the number of processed bits per second of the NIC are relevant, not the particular type of the NIC, which is independent from the embodiments of the invention.

Nodes 220, 221, 222, L (and others) forming cluster 203 can be an heterogeneous set of single-processor and multi-core units, commodity PC, or high-availability servers supporting the MPI standard. The configuration of the cluster, including the number of available CPUs and NIC, should suit the load of data sent by the exchange and allow sufficient computing resources to process all the events in real-time

Market data events are sequentially stored in the common data queue 201 residing on one of the cluster nodes 220-L. The queue operates on a FIFO (first in, first out) basis and the order of the events is preserved, as determined by the electronic exchange. As one or more events are stored in the data queue, the first available MPI process in 202 will start processing an event on a target CPU while other processes might be engaged in processing a different event on a different CPU in the same cluster, thus significantly improving workload efficiency.

The distribution of market data events in the FIFO queue is implemented synchronizing each MPI process over the process memory where the data queue resides, by the means of atomic operations. The queue 201 takes the form of an inter-process, multiple-producer/multiple-consumers, or single-producer/multiple-consumers distributed queue, where each event can be submitted by one or more processes in the cluster and consumed by the first available MPI task in 202.

For example, assuming the aforementioned case of a high-volume security producer typical of an electronic market data system, an operating system process residing on the computing cluster 203 is dedicated to the reception of exchange messages and the insertion in queue 201. A trading execution is delivered to the process herein described. After the message has been inserted in the queue, any of the tasks in 202 can read the queue and process the event. Specifically, the first idle task N in the list of operating system processes reads the trade event from the queue while synchronizing with the other tasks in 202 for queue access. This operation is performed across all the tasks in the cluster to preserve the consistency of the shared queue state against concurrent access from multiple consumers. It should be understood that at this point in the described scenario, the events might be processed in an order that is different from the order of the original delivery, as the tasks in 202 are executing in parallel, thereby improving utilization of computing resources.

After the event has been removed from the shared queue by task N, one or more of the following scenarios might take place, as specified by the user in the configuration of the system: data can be stored for later analysis by another program; data can be delivered to another process for real-time analysis; a sets of user instructions can be executed directly in the operating system process running task N, thus avoiding any additional communication overhead; the event is delivered to the PMDS system 204 described below.

It should be noted that the process and the tasks configuration presented in the example above is only one of the possible logical setups. The operating system process dedicated to the reception of the exchange messages might run on different hardware than cluster 203. The task reading and processing events from the queue might be a dedicated one, rather than the first available for processing. There might be more than one queue 201, each dedicated to a specific set of securities data or electronic exchanges. The user might decide to dedicate a subset of tasks 202 to a specific queue. In general, the benefit of the embodiments of the invention is to guarantee concurrent access from multiple processes over sequential real-time data, while maintaining the consistency of the same data.

One or more MPI tasks in 202 can be allocated to subsets of securities by the cluster administrator to provide load-balancing based on an estimation of market volumes for each securities subset.

Additionally, the trading system user can dynamically allocate one or more CPU cores available on the cluster to a specific subset of instruments, either at the beginning of the program or dynamically during program execution.

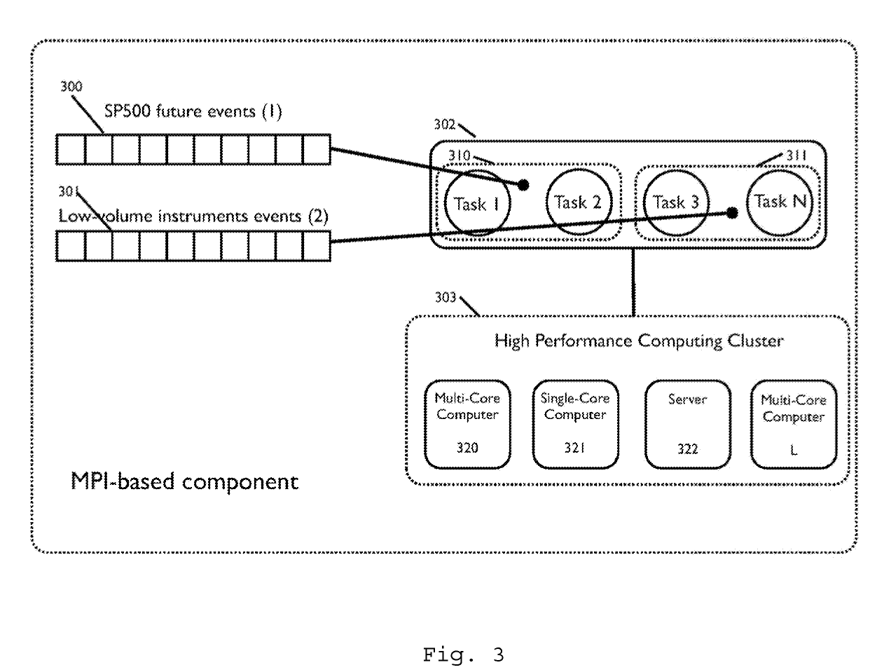

FIG. 3 illustrates a trading system market data component in accordance with one or more alternative embodiments of the invention. This embodiment illustrates multiple data queues 300, 301 received from one or more exchanges (not shown in this figure). Queue 300 in this example receives data from a high-volume events producer such as the S&P500 mini-future contract traded on Globex (CME). Queue 301 receives data on low-volume instruments events. The cluster administrator can allocate an MPI task subgroup 310 (containing multiple tasks) to process events on the high-volume events queue to improve reliability in times of market stress and peak volumes. At the same time, a number of low volume, low-activity instruments can be dedicated to a different MPI task sub-group 311 to form a pool of tasks processing a lower number of market events.

The organization of instruments in different groups allows the allocation of one distribution queue for each group. In the FIG. 3 example, S&P500 future events will be allocated to queue (1) 300, while all the events for the instruments included in the second group will be allocated to queue (2) 301. In accordance with one or more embodiments, the distribution of events in each queue by instrument group improves optimization of system resources and simplifies data distribution. It should be understood that the allocation of the tasks per instrument is not limited to the examples presented herein, and it can take other forms. In facts, production-level configurations may include several thousand securities marketed on a multitude of exchanges, thus increasing the number of queues, computers and tasks involved in the workflow.

Some examples of the operations executed by the tasks in 302, 310, 311 are: recording of each event on mass-storage device, such as a Redundant Array of Independent Disks (RAID) or a local hard disk; conversion of the event data format from an exchange-specific protocol to a local trading system common format, including Parallel Market Data System (PMDS) format 204; filtering of market data based on user requirements, such as deviation from the last traded price, or maximum number of delivered events per second, or type of the event.

After the MPI task in 202 has processed the market event, a new data message is prepared for distribution to the system identified as Parallel Market Data System (PMDS) 204 in FIG. 2. PMDS can provide a complete view on all market data events, indexed by instrument. This can include, but it is not limited to, for each instrument: the last transaction price and size; the last best offered price and size; the last best requested price and size; the list of all active orders on the buy and sell books. Additionally, PMDS can record a configurable number of last historical updates that can be used by external components to analyze high-frequency historical time-series.

Due to the asynchronous nature of workload distribution presented in FIG. 1, PMDS provides the correct sequence of events by verifying (a) a sequence number in each instrument/event message, or (b) the exchange time-stamp associated with each update. The system administrator can configure PMDS to either (1) accept the most recent event X in the internal time-series array, thus discarding any older event received after X in cases where data consistencies can be preserved or (2) hold the out-of-sequence event for a certain time in a pending queue and insert the same event in the internal time-series array only after the correct sequence is re-established or after a configurable time-out has expired.

In accordance with one or more embodiments, the full PMDS data-set can be organized as a static, contiguous memory space in an MPI-2 one-sided memory window for Remote Memory Access (RMA). This type of memory management allows data access from multiple processes in the same MPI communicator, avoiding the overhead of a point-to-point request/reply transaction, and providing access synchronization to the same physical memory space from multiple independent processes in the HPC cluster. A number of MPI-2 implementations delegate the execution of RMA operations to lower-level APIs matching the features of the underlying hardware (such as Infiniband) to optimize network performances. Examples of high-performance RMA layers that can be used in MPI-2 implementations are IBM's Low-level Applications Programming Interface (LAPI), Hewlett Packard's HyperFabric/Hyper Messaging Protocol (HMP), and OpenFabrics Infiniband verbs.

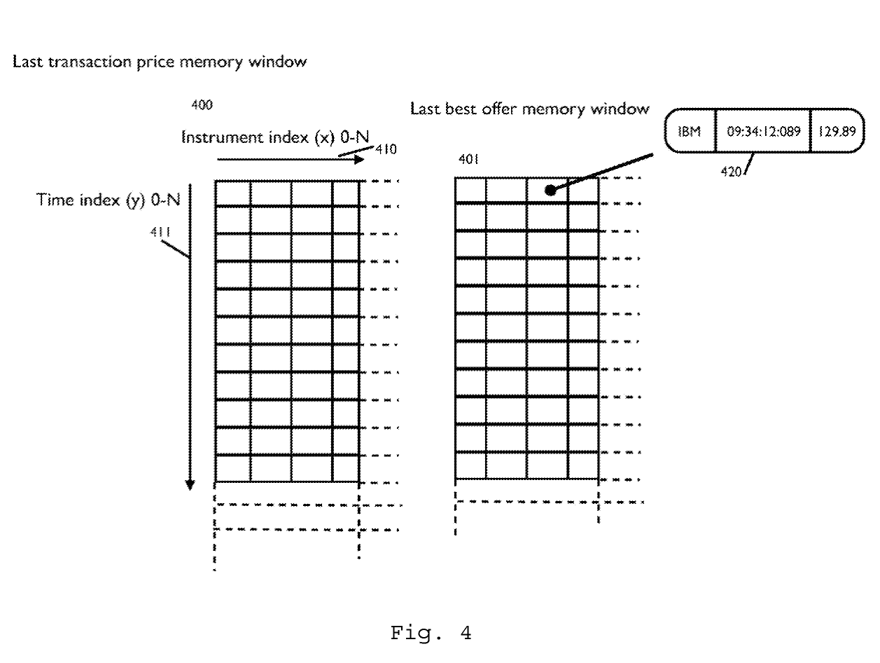

In accordance with one or more embodiments, as shown in FIG. 4, data recorded in PMDS is represented as a set of two-dimensional arrays where dimension x 410 indicates a specific instrument in the memory database, y 411 is a time-ordered index indicating one of the last N updates and N is a parameter defined by the user. For example, if the component is configured to handle the last 50 updates, equity instrument “IBM” will be identified by index 905 in the array and the last transaction in order of time will be identified by index 0. Index 1 will point to the second-last transaction size, index 2 to the third-last transaction size and so on. In addition, all the elements in the array will include a time-stamp of millisecond precision to uniquely identify the market event as illustrated in 420.

Given that market events might occur at different points in time (e.g., a best offer price is received 1 second before a best buy price for the same instrument) and to provide increased flexibility to the user accessing the PMDS API, a two-dimensional array is created for each market data event type, in a specific MPI-2 RMA window 401.

In accordance with one or more embodiments, a basic API is provided to allow access to each market data event from an external component, using the following logical functions:

(1) PMDS_Attach(Component, InstrumentId); opens access to the PMDS system to start perform reading operations for instrument ‘instrumented’. This function returns a memory id handler that will be later used in PMDS_Detach to disconnect form this memory window.

(2) PMDS_Get(EventId, Index, Data); read event type ‘EventId’, index ‘Index’ and place the value in memory buffer supplied by ‘Data’. The type of ‘Data’ is relative to the requested event type. In addition to the request contents, the ‘Data’ buffer will include a time-stamp for the event, as transmitted by the exchange or, alternatively, set by the component at the time of the reception.

(3) PMDS_Detach(MemoryId); close a connection from memory window ‘MemoryId’.

It should be noted that PMDS data access is not limited to MPI-2 RMA. Data can be distributed by PMDS through a proprietary middleware, a commercial systems such as Tibco Rv or IBM MQSeries, a DDS-based implementation for real-time data distribution or an MPI-1 request-reply transaction.

The methods and systems in accordance with various embodiments provide a real-time, cluster-based time-series database, along with synchronization of MPI processes using atomic MPI operations. The performance and the number of instruments and events manageable by a market data system is increased relatively to the available processing units in the cluster.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above are preferably implemented in software, and accordingly one of the preferred implementations of the invention is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD or DVD ROM) or floppy disk (for eventual use in a floppy disk drive), a removable storage device (e.g., external hard drive, memory card, or flash drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A method for real-time, asynchronous processing of financial market data events on a parallel computing platform having a plurality of computer processes executing on one or more computers, comprising:
(a) receiving a generally continuous stream of market data events from an electronic exchange over a computer network;
(b) sequentially storing the market data events received in (a) in at least one data queue;
(c) distributing the market data events among the plurality of computer processes on a first in, first out basis such that the market data events can be processed by the processes in a coordinated fashion;
(d) processing the market data events distributed in (c) at the respective computer processes using financial models to generate trading information on one or more financial instruments; and
(e) making the trading information generated in (d) available through a common API or a client application to a user.

2. The method of claim 1 wherein the one or more computers comprise a cluster of computers connected by high-performance network interface cards.

3. The method of claim 1 wherein the trading information is used for pricing financial instruments, managing risk, or automatically making trading decisions.

4. The method of claim 1 wherein the market data events are distributed among the plurality of computer processes using atomic operations.

5. The method of claim 1 wherein the market data events are distributed among the plurality of computer processes based on load-balancing.

6. The method of claim 1 wherein computer processes are allocated to market data events associated with subsets of financial instruments to provide load-balancing based on estimated market volumes of each subset of financial instruments.

7. The method of claim 1 wherein the market data events are distributed among the plurality of computer processes using an MPI standard.

8. The method of claim 1 wherein the trading information is organized in a memory window for remote memory access (RMA) to allow data access from multiple processes in a single MPI communicator.

9. The method of claim 1 wherein the at least one data queue comprises a plurality of data queues, with each queue storing events relating to particular financial instruments, and wherein the method further comprises allocating each process to process events from a particular queue.

10. The method of claim 1 wherein the trading information is ordered in accordance with a sequence number or timestamp associated with a corresponding event.

11. The method of claim 1 further comprising converting the event data from an exchange specific format to a local trading system format.

12. The method of claim 1 wherein (e) comprises representing the trading information as a set of two dimensional arrays where one dimension indicates a particular instrument and another dimension indicates a time ordered index indicating one of the last N updates, where N is a parameter defined by the user.

13. The method of claim 1 wherein the at least one data queue comprises an inter-process, multiple-producer/multiple-consumer distributed queue or a single-producer/multiple-consumer distributed queue, and wherein each market data event can be submitted by one or more processes and consumed by the first available process.

14. A system for real-time, asynchronous processing of financial market data events on a parallel computing platform having a plurality of computer processes executing on one or more computers, comprising:
a market data component for receiving a generally continuous stream of market data events from an electronic exchange over a computer network, and sequentially storing the market data events received in at least one data queue;
a computing cluster comprising a plurality of computer processes;
a process for distributing the market data events among the plurality of computer processes in the computing cluster on a first in, first out basis such that the market data events can be processed by the processes in a coordinated fashion using financial models to generate trading information on one or more financial instruments; and
a process for making the trading information available through a common API or a client application to a user.

15. The system of claim 14 wherein the one or more computers comprise a cluster of computers connected by high-performance network interface cards.

16. The system of claim 14 wherein the trading information is used for pricing financial instruments, managing risk, or automatically making trading decisions.

17. The system of claim 14 wherein the market data events are distributed among the plurality of computer processes using atomic operations.

18. The system of claim 14 wherein the market data events are distributed among the plurality of computer processes based on load-balancing.

19. The system of claim 14 wherein computer processes are allocated to market data events associated with subsets of financial instruments to provide load-balancing based on estimated market volumes of each subset of financial instruments.

20. The system of claim 14 wherein the market data events are distributed among the plurality of computer processes using an MPI standard.

21. The system of claim 14 wherein the trading information is organized in a memory window for remote memory access (RMA) to allow data access from multiple processes in a single MPI communicator.

22. The system of claim 14 wherein the at least one data queue comprises a plurality of data queues, with each queue storing events relating to particular financial instruments, and wherein the method further comprises allocating each process to process events from a particular queue.

23. The system of claim 14 wherein the trading information is ordered in accordance with a sequence number or timestamp associated with a corresponding event.

24. The system of claim 14 further comprising converting the event data from an exchange specific format to a local trading system format.

25. The system of claim 14 wherein making the trading information available comprises representing the trading information as a set of two dimensional arrays where one dimension indicates a particular instrument and another dimension indicates a time ordered index indicating one of the last N updates, where N is a parameter defined by the user.

26. The system of claim 14 wherein the at least one data queue comprises an inter-process, multiple-producer/multiple-consumer distributed queue or a single-producer/multiple-consumer distributed queue, and wherein each market data event can be submitted by one or more processes and consumed by the first available process.
